(19) United States
(12) Patent Application Publication
(10) Pub. No.: US 2020/0273096 A1
(43) Pub. Date: Aug. 27, 2020

(54) SYSTEM AND METHOD FOR IMPLEMENTING A COMMUNITY DEVELOPMENT PRODUCTION REPORTING APPLICATION

(71) Applicant: JPMorgan Chase Bank, N.A., New York, NY (US)

(72) Inventors: Eric C. HADLEY, Galena, OH (US); Sumnesh MADHU, Lewis Center, OH (US); Melissa AELKER, New Albany, OH (US)

(21) Appl. No.: 16/285,715

(22) Filed: Feb. 26, 2019

(51) Int. Cl. G06Q 40/02; G06Q 30/00

(52) U.S. Cl. CPC G06Q 40/02; G06Q 30/018

(57) ABSTRACT

An embodiment of the present invention is directed to a centralized system that implements community development performance reporting tool. The system comprises a programmed computer processor executing an application and further configured to perform the steps of: receiving, via an electronic input, data from a plurality of data feeds representing loans data, investment data, grant data and services data; providing, via the user interface, an interactive display that generates loan type data and record status data wherein the interactive display is configured to receive an input identifying a community reinvestment reportability determination of a current record; providing a free-form text input to support the community reinvestment reportability determination for the current record; and enabling, via the user interface, the user to track, analyze and evaluate community reinvestment reportability determinations.

### FIELD OF THE INVENTION

The invention relates generally to a system and method for implementing a community development production reporting application.

### BACKGROUND OF THE INVENTION

The Community Reinvestment Act (CRA) is a United States federal law designed to encourage commercial banks and savings associations to help meet the needs of borrowers in all segments of their communities, including low and moderate income neighborhoods. The Act instructs the appropriate federal financial supervisory agencies to encourage regulated financial institutions to help meet the credit needs of the local communities in which they are chartered, consistent with safe and sound operation. To enforce the statute, federal regulatory agencies examine banking institutions for CRA compliance, and take this information into consideration when approving applications for new bank branches as well as for mergers or acquisitions.

Currently, CRA analysts do not have a central location where they are able to analyze Loans, Grants, and Investments to determine if they are CRA Reportable. Instead, such data exists in various separate and disparate data sources thereby resulting in inconsistencies in the data and delays in properly collecting the information. Further, because the data is maintained on disparate systems, there are no controls or safeguards to protect the data and ensure its reliability.

These and other drawbacks exist.

### SUMMARY OF THE INVENTION

According to one embodiment, the invention relates to a system that implements a community development production reporting application. The system comprises: an user interface that receives an input from an analyst user; a memory component that stores community reinvestment data; and a computer server coupled to the user interface and the memory, the computer server comprising a programmed computer processor executing an application and further configured to perform the steps of: receiving, via an electronic input, data from a plurality of data feeds representing loans data, investment data, grant data and services data; providing, via the user interface, an interactive display that generates loan type data and record status data wherein the interactive display is configured to receive an input identifying a community reinvestment reportability determination of a current record; providing a free-form text input to support the community reinvestment reportability determination for the current record; and enabling, via the user interface, the user to track, analyze and evaluate community reinvestment reportability determinations.

According to another embodiment, the invention relates to a method that implements a community development production reporting application. The method comprises the steps of: receiving, via an electronic input, data from a plurality of data feeds representing loans data, investment data, grant data and services data; providing, via the user interface, an interactive display that generates loan type data and record status data wherein the interactive display is configured to receive an input identifying a community reinvestment reportability determination of a current record; providing a free-form text input to support the community reinvestment reportability determination for the current record; and enabling, via the user interface, the user to track, analyze and evaluate community reinvestment reportability determinations.

The system may include a specially programmed computer system comprising one or more computer processors, interactive interfaces, electronic storage devices, and networks.

The computer implemented system, method and medium described herein provide unique advantages to entities, organizations and other users, according to various embodiments of the invention. An embodiment of the present invention seeks to address the lack of efficiency around the processing and analysis of Community Development data for a large scale bank or other entity. With various banks recently increasing their investment in Community Development, possessing a centralized location where CRA analysts can easily access and evaluate CRA Reportable records is becoming very important. By providing a centralized system, the innovation ensures consistency in regulation compliance and a standardized reporting process. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flowchart that illustrates accessibility to CRA data, according to an embodiment of the present invention.

FIG. 2 is an exemplary system diagram that illustrates a Community Development Production Reporting (CDPR) system, according to an embodiment of the present invention.

FIG. 3 is an exemplary screenshot of a Community Development Production Reporting (CDPR) system, according to an embodiment of the present invention.

FIG. 4 is an exemplary screenshot of a Community Development Production Reporting (CDPR) system, according to an embodiment of the present invention.

FIG. 5 is an exemplary screenshot of a Community Development Production Reporting (CDPR) system, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to a central internal web-based application where Community Reinvestment Act (CRA) analysts may track, analyze, and evaluate their CRA Reportability. Once users, such as analysts, are on-boarded to the application, they may receive instant permissions to the data through an interactive interface, such as a web portal. Users may be given the ability to enter additional data, add loan-level comments as well as ultimately set the record to CRA Reportable or not. Other functions and actions may be realized.

Conventional systems and platforms require dependencies on software that lead to set-up issues. The tool of an embodiment of the present invention enables users to bulk load monthly (or other periodic) loans, grants, and/or investments through the system as opposed to having to manually enter the data into the database. An embodiment of the present invention may provide a suite of Administrative Tools that enable users to manage the content of the drop-down box controls, and complete various other administrative functions through the self-service tools.

An embodiment of the present invention provides a centralized hub for tracking community development activity for loans, grants, investments and/or services from disparate sources. Another embodiment of the present invention enables users to review data at various levels and push the data into the final target tables (or other target format) after vetting is completed. In addition, users may customize the application to adapt to ever-changing application content with a suite of Administrative Tools, provided by an embodiment of the present invention. Users may further closely monitor, validate and/or load data into the application in bulk and/or reject invalid data sets. This may occur after the CRA analyst experts have validated the data so that the data then becomes “live” in the system.

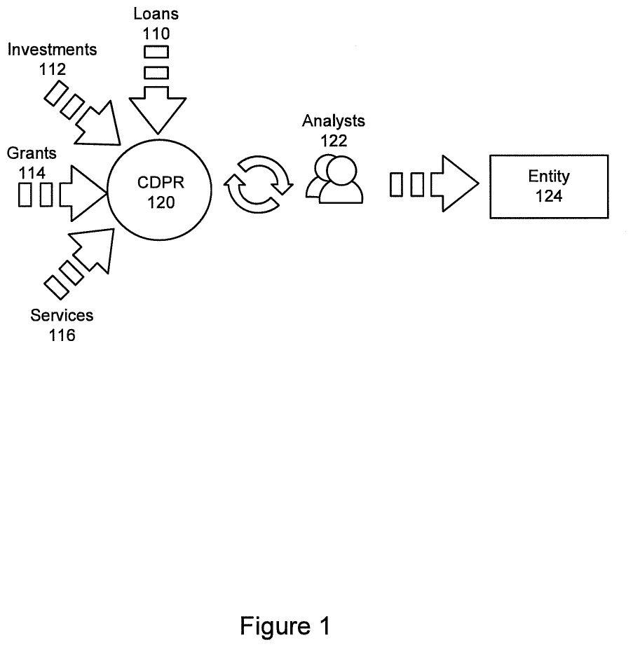

FIG. 1 is an exemplary flowchart that illustrates accessibility to CRA data, according to an embodiment of the present invention. As shown in FIG. 1, a Community Development Production Reporting (CDPR) system may receive data from various disparate sources, represented by Loans 110, Investments 112, Grants 114 and Services 116. Loans may include business banking, personal loans, etc. Grants may include employment and other grants.

Investments may include direct and funds. Services may include transfers, mortgages and other services. With an embodiment of the present invention, a Community Development Analyst 122 may be securely and efficiently on-boarded to the system, and given permissions to track, analyze and/or evaluate their Community Reinvestment Act (CRA) Reportability. Depending on their role, analysts may instantly have access to some or all of the available features. Analysts 122 may perform various functions including analysis, research and reportability determinations. In addition, Analysts 122 may transmit submissions to an entity, including a government entity such as Federal Reserve Board 124. For example, a system may submit periodic reports to a government agency. Other recipients and/or intermediaries may be implemented.

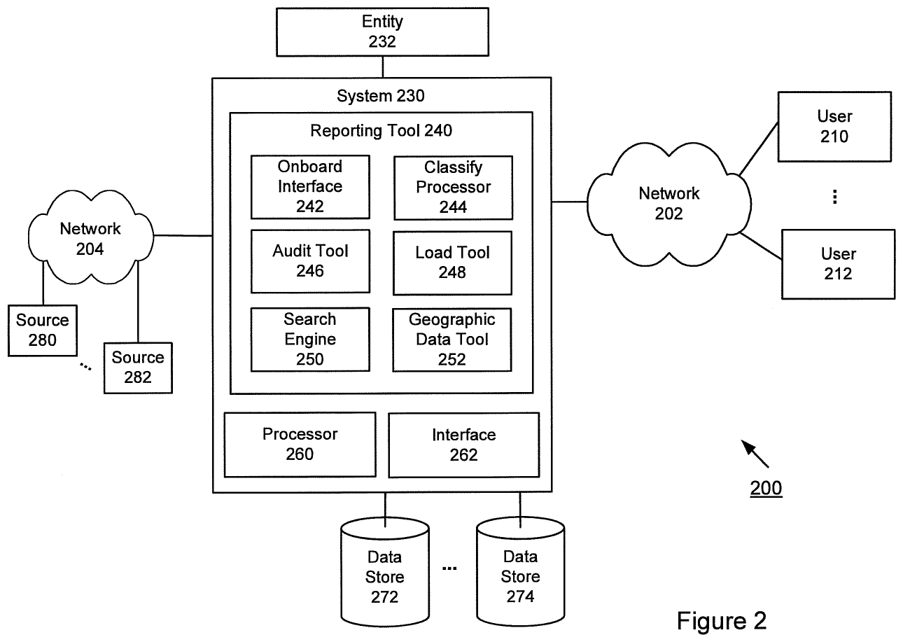

FIG. 2 is an exemplary system diagram that illustrates a Community Development Production Reporting (CDPR) system, according to an embodiment of the present invention. As illustrated in FIG. 2, System 230 may be communicatively coupled, via Network 202, with one or more data devices including, for example, computing devices associated with end users, represented by User 210, 212. Users may represent analysts, administrators, managers, etc. Computing devices may include computers, laptops, workstations, kiosks, terminals, tablets, mobile devices, mobile phones, smart devices, etc. System 230 may include a Reporting Tool 240, Processor 260, Interface 262 and/or other modules and interfaces.

In accordance with the various features of an embodiment of the present invention, Reporting Tool 240 may manage CRA data and reporting through modules, processing components and/or interfaces, including Onboard Interface 242, Classify Processor 244, Audit Tool 246, Load Tool 248, Search Engine 250 and Geographic Data Tool 252. Other functions may be implemented. These modules, components and functions are exemplary and illustrative, System 230 may interact with additional modules, a combination of the modules described and/or less modules than illustrated. While a single illustrative block, module or component is shown, these illustrative blocks, modules or components may be multiplied for various applications or different application environments. The modules and/or components may be further duplicated, combined and/or separated across multiple systems at local and/or remote locations. Other architectures may be realized.

Onboard Interface 242 facilitates an analyst onboarding process. Analysts may be onboarded and given permissions to track, analyze and evaluate CRA reportability data.

Classify Processor 244 may represent Reportability determinations for specific records. An embodiment of the present invention may consider various conditions that make a record reportable as opposed to not reportable. For example, the Community Reinvestment Act (CRA) represents a federal regulation which encourages financial institutions to help meet the credit needs of their local communities, including low- and moderate-income (LMI) neighborhoods. To be classified as Community Development, the record may be required to include one of the following: (a) Affordable Housing (AH); (b) Economic Development (ED); (c) Revitalization/Stabilization (RS); and d) Community Service (CS).

For example, Affordable Housing (AH) may include housing (including multifamily rental housing) for low- or moderate-income (LMI) individuals. Economic Development may include activities that promote economic development by financing businesses and/or farms that meet the regulatory size test and support permanent job creation, retention, and/or improvement for LMI persons or in LMI geographies. Revitalization/Stabilization (RS) may represent activities that revitalize and/or stabilize LMI geographies designated disaster areas or distressed/underserved areas. Community Service (CS) may represent community services targeted to LMI individuals. Other reportability classifications and determinations may be supported by an embodiment of the present invention.

Audit Tool 246 may enable the analyst to track and record various actions and status data associated with a record. For example, Audit Tool 246 may capture activity and actions taken with respect to a particular record. This may include who accessed what data, when the data was accessed as well as any updates, changes, modifications made to the data, etc. Accordingly, Audit Tool 246 may provide a detailed history of any record as well as details that support any record. Audit records may also be searchable and formatted into reports and/or other outputs.

Load Tool 248 may facilitate a data load process where data may be pushed to a receiving application and/or tool. Analysts may monitor, validate and/or load data into the CDPR system in bulk and/or reject invalid data sets. For example, Load Tool may further enable an analyst to exclude records not required to be loaded into the CDPR system. Accordingly, an analyst may review data prior to the data being uploaded as a final check.

Search Engine 250 may enable analysts to search for and access specific records across multiple data type feeds, including loans, investments, grants and services. Other data feed types may be supported.

Geographic Data Tool 252 provides analysts with real-time information about a location's assessment area as well as tract income level. Geographic Data Tool 252 may also provide other geographic data relevant to a reportability determination.

System 230 may be communicatively coupled to data storage devices represented by Data Stores 272, 274. Data Stores 272, 274 may represent any suitable data structure to maintain the information and allow access and retrieval of the information. The storage components may also represent cloud or other network based storage. System 230 may interface with various other storage systems, including distributed systems. The community development production reporting functionality described herein may be provided by System 230 and/or a third party provider, represented by Entity 232, where System 230 may operate with Entity 230. System 230 may further interface, via Network 204, with various sources represented by 280 and 282 which may represent disparate sources of data. For example, Sources 280 and 282 may provide data relating to Loans, Investments, Grants and Services.

System 200 of FIG. 2 may be implemented in a variety of ways. Architecture within system 200 may be implemented as hardware components (e.g., module) within one or more network elements. It should also be appreciated that architecture within system 200 may be implemented in computer executable software (e.g., on a tangible, non-transitory computer-readable medium) located within one or more network elements. Module functionality of architecture within system 200 may be located on a single device or distributed across a plurality of devices including one or more centralized servers and one or more mobile units or end user devices. The architecture depicted in system 200 is meant to be exemplary and non-limiting. For example, while connections and relationships between the elements of system 200 is depicted, it should be appreciated that other connections and relationships are possible. The system 200 described below may be used to implement the various methods herein, by way of example. Various elements of the system 200 may be referenced in explaining the exemplary methods described herein.

Network 202, 204 may be a wireless network, a wired network or any combination of wireless network and wired network. Although Network 202, 204 is depicted as one network for simplicity, it should be appreciated that according to one or more embodiments, Network 202, 204 may comprise a plurality of interconnected networks, such as, for example, a service provider network, the Internet, a cellular network, corporate networks, or even home networks, or any of the types of networks mentioned above. Data may be transmitted and received via Network 202, 204 utilizing a standard networking protocol or a standard telecommunications protocol.

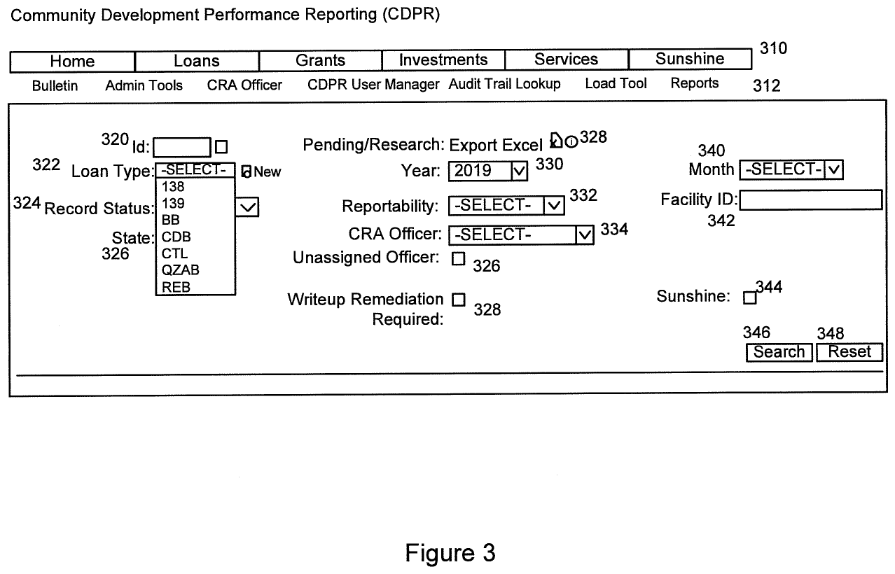

FIG. 3 is an exemplary screenshot of a Community Development Production Reporting (CDPR) system, according to an embodiment of the present invention. FIG. 3 illustrates an exemplary central loans search page interface. FIG. 3 includes Data Sources at 310 and various Tools at 312. Data Sources 310 may include represent data feeds from various sources, such as Home, Loans, Grants, Investments, Services and Sunshine. In this exemplary illustration, Sunshine represents a regulation, e.g., Regulation G CRA Sunshine Regulation G, Disclosure and Reporting of CRA. For example, Related Agreements, implements the CRA Sun shine Requirements, which were added to the Federal Deposit Insurance Act (FDI Act). Sunshine may represent a specific forms within the application.

Tools 312 may include Bulletin, Admin Tools, CRA Officer, User Manager, Audit Trail Lookup, Load Tool and Reports. Tools 312 provide controls and safeguards to ensure that the data is reliable and available to authorized analysts and users. This may be particular important for submissions made to a government entity.

As shown in FIG. 3, a central loans search page allows CRA analysts to easily search for and access specific record across various separate data type feeds, represented by 310. The form layout allows users easy access to loans they have been researching and processing by leveraging the CRA Officer Drop Down box at 334.

FIG. 3 may include ID field at 320, Loan Type field at 332, Record Status field at 324, State field at 326, Pending/Research at 328, Year field at 330, Reportability field at 332, CRA Officer field at 334, Unassigned Officer 336, Write-up Remediation at 338, Month at 340, Facility ID at 342, Sunshine at 344, Search 346 and Reset 348.

For example, Loan Type field 322 may include a set of possible loan types. Loan Types may include business banking (BB), credit tenant lease (CTL), student loans, personal loans and other types of loans. Record Status field 324 may include a set of possible states including Complete, New, Pending Docs, Research, and Void. Within each Loan, Grant, Investment, and Service, an embodiment of the present invention empowers the user to easily classify the record as CRA Reportable or Non-Reportable through the global web interface at 332. For example, Reportability field 332 may enable CRA Officer leads and management to easily track records that have been classified as CRA Reportable. According to an embodiment of the present invention, whether a record is reportable or not may be an automated recommendation based on certain key factors, as described above. For example, the system may provide a recommended reportability state where the analyst may approve or override. The system may also provide support and/or evidence for the reportability recommendation to assist the analyst's decision.. The system may apply a learning algorithm that adjusts for improved accuracy based on prior reportability determinations. Other variations may be implemented. The Record Status field 324 may enable users to search for records at various different stages of research progression.

The CDPR application provides users the ability to promote monthly or other periodic data loads to become “live” within the application. For example, once the data has been confirmed by a CRA subject matter expert, the data may be accessible to CRA Officers in the CDPR system.

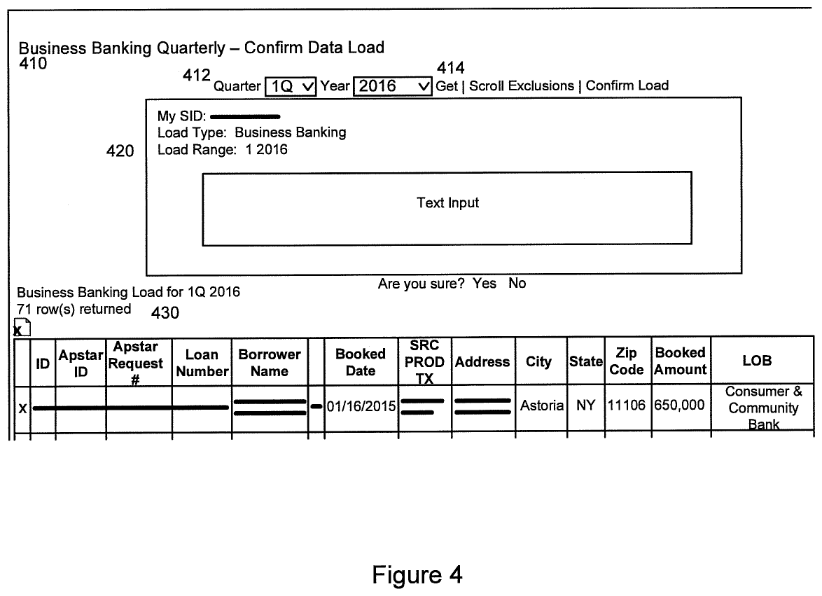

FIG. 4 illustrates an exemplary screenshot of a Community Development Production Reporting (CDPR) system, according to an embodiment of the present invention.

FIG. 4 illustrates an exemplary business banking quarterly confirm data load page at 410. A time period may be identified by Quarter field 412 and Year field at 414. Section 420 displays an input field where users may provide a narrative regarding a specific record. The content of the narrative may be used as evidence to support their CRA Reportable classification. In addition, external documents, attachments, images and/or links may be attached or otherwise associated with the record. Further, data from other sources (e.g., data input application or tool) may be automatically inputted into the field in a predetermined and compatible format.

Results of the data load may be displayed at 430. Data may be displayed in a table or other format. FIG. 4 illustrates an exemplary format that includes ID, Request Number, Load Number, Borrower Name, Booked Date, Production TX; Address, City, State, Zip Code, Amount Booked, Line of Business (LOB). FIG. 4 represents a load tool interface that provides users the ability to manually exclude records not required to be loaded into CDPR, as shown by 430. For example, this exemplary feature provides a final data quality checkpoint to further ensure data quality.

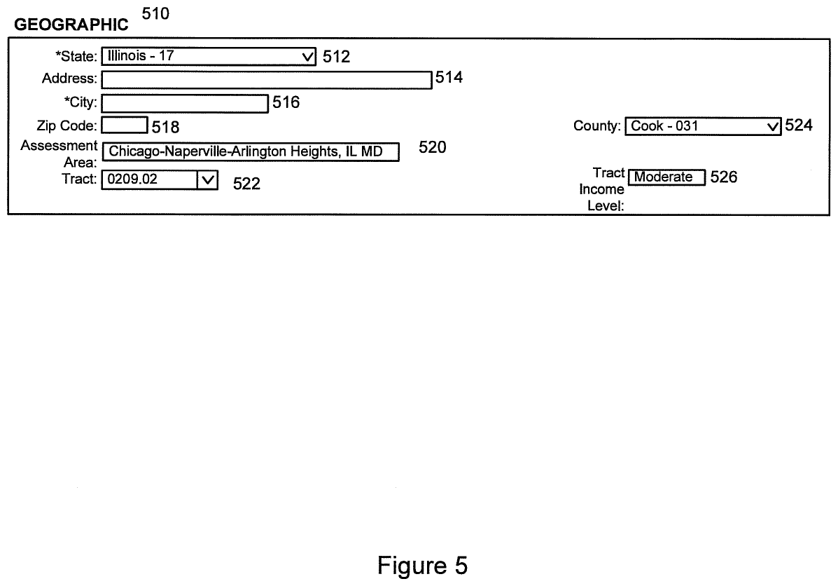

FIG. 5 illustrates an exemplary screenshot of a Community Development Production Reporting (CDPR) system, according to an embodiment of the present invention. Records in the CDPR application may contain a Geographic Section 510 designed to provide CRA Analysts real time information about a specific location's Assessment Area, and Tract Income Level. According to an exemplary embodiment, Geographic Section 510 may include State field 512, Address field 514, City field 516, Zip Code field 518, Assessment field 520, Area Tract 522, County field 524 and Tract Income Level field 526. Other fields and variations may be implemented.

When the record's State (512) and County (524) combination are selected from drop down boxes, the associated Assessment Area may be conveniently displayed to the user. Assessment Area values may be provided in real-time with current definitions. Also, when a specific County in selected at 524, a drop down list of associated Census Tracts may also be provided to the user.

For example, when a user selects a Census Tract for their record, an embodiment of the present invention may present the user with a Census Tract Income Level at 526. The Census Tract Income Level 526 may be particularly useful to analyzing the CRA Reportability of the record. Accordingly, the logical progressive nature of the Geographic section provides the user with important Geographical information on records they are researching in real time.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A centralized system that implements community development performance reporting tool, the system comprising:
an user interface that receives an input from an analyst user;
a memory component that stores community reinvestment data; and
a computer server coupled to the user interface and the memory, the computer server comprising a programmed computer processor executing an application and further configured to perform the steps of:
receiving, via an electronic input, data from a plurality of data feeds representing loans data, investment data, grant data and services data;
providing, via the user interface, an interactive display that generates loan type data and record status data wherein the interactive display is configured to receive an input identifying a community reinvestment reportability determination of a current record;
providing a free-form text input to support the community reinvestment reportability determination for the current record; and
enabling, via the user interface, the user to track, analyze and evaluate community reinvestment reportability determinations.

2. The system of claim 1, wherein the analyst user is on-boarded with permissions to track analyze and evaluate community reinvestment reportability determinations.

3. The system of claim 1, wherein one or more options of the interactive display are customized to adapt to changing application content via an administrative tool.

4. The system of claim 1, wherein the analyst user searches for and accesses records across a plurality of data feeds.

5. The system of claim 1, wherein the analyst user searches for records at a plurality of different stages of progression.

6. The system of claim 1, wherein one or more records are excluded by a load tool.

7. The system of claim 1, wherein the interactive display comprises a geographic section that provides real-time information about a specific location assessment area.

8. The system of claim 1, wherein the interactive display comprises a geographic section that provides real-time information about a tract income level.

9. The system of claim 1, wherein the interactive display comprises an assessment area value.

10. The system of claim 1, wherein the interactive display comprises a census tract income level to analyze community reinvestment reportability of a record.

11. A method that implements community development performance reporting tool, the method comprising the steps of:
receiving, via an electronic input, data from a plurality of data feeds representing loans data, investment data, grant data and services data;
providing, via the user interface, an interactive display that generates loan type data and record status data wherein the interactive display is configured to receive an input identifying a community reinvestment reportability determination of a current record;
providing a free-form text input to support the community reinvestment reportability determination for the current record; and
enabling, via the user interface, the user to track, analyze and evaluate community reinvestment reportability determinations.

12. The method of claim 11, wherein the analyst user is on-boarded with permissions to track analyze and evaluate community reinvestment reportability determinations.

13. The method of claim 11, wherein one or more options of the interactive display are customized to adapt to changing application content via an administrative tool.

14. The method of claim 11, wherein the analyst user searches for and accesses records across a plurality of data feeds.

15. The method of claim 11, wherein the analyst user searches for records at a plurality of different stages of progression.

16. The method of claim 11, wherein one or more records are excluded by a load tool.

17. The method of claim 11, wherein the interactive display comprises a geographic section that provides real-time information about a specific location assessment area.

18. The method of claim 11, wherein the interactive display comprises a geographic section that provides real-time information about a tract income level.

19. The method of claim 11, wherein the interactive display comprises an assessment area value.

20. The method of claim 11, wherein the interactive display comprises a census tract income level to analyze community reinvestment reportability of a record.
